(19) United States
(12) Patent Application Publication
(10) Pub. No.: US 2025/0356720 A1
(43) Pub. Date: Nov. 20, 2025

(54) ANIMATED LIGHTING EFFECTS FOR ROULETTE

(71) Applicant: Interblock d.o.o., MENGES (SI)

(72) Inventors: James Preston, Macau (MO); John Joseph Connelly, Las Vegas, NV (US)

(21) Appl. No.: 19/278,042

(22) Filed: Jul. 23, 2025

Related U.S. Application Data
(63) Continuation-in-part of application No. 18/603,990, filed on Mar. 13, 2024.
Application No. 18/603,990 is a continuation-in-part of application No. 18/319,238, filed on May 17, 2023.
(60) Provisional application No. 63/483,246, filed on Feb. 3, 2023.
(60) Provisional application No. 63/674,638, filed on Jul. 23, 2024.

(51) Int. Cl. G07F 17/32

(52) U.S. Cl. CPC G07F 17/3211

(57) ABSTRACT

A roulette wheel system and method of using are disclosed. A roulette wheel may include a rotatable rim, a controller, and an optical display system. The optical display system may be configured to project a lighting effect on a top surface of the roulette wheel. The lighting effect corresponds to bet information. As the bet information changes the lighting effect is dynamically updated. A controller may provide signal content to the optical display system to produce the signal content.

### CROSS-REFERENCE TO RELATED APPLICATIONS

The present application claims priority to U.S. Provisional Application No. 63/674,638, filed Jul. 23, 2024; and is a continuation-in-part of U.S. patent application Ser. No. 18/603,990, filed Mar. 13, 2024; which is a continuation-in-part of U.S. patent application Ser. No. 18/319,238, filed May 17, 2023; and claims priority to U.S. Provisional Application No. 63/483,246, filed Feb. 3, 2023; each of which are incorporated herein by reference.

### TECHNICAL FIELD

The present disclosure relates to a gaming apparatus and more particularly to visual displays associated with a roulette gaming apparatus or systems and methods for using the same.

### BACKGROUND

Roulette is a popular game played in gaming establishments. In mechanical versions of the game (versus video generated), a roulette ball is launched into a stationary rim having a single, angled annular track encircling a spinning roulette wheel. The spinning wheel rotates in the opposite direction of the spinning roulette ball. The roulette ball spins around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually, the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number and color. The particular number represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number and color on the layout corresponding to the ball slot in which the roulette ball came to rest. Winning and losing selections for that game cycle that had been electronically or physically placed on the selection area prior to a selection close time of that game cycle are then determined according to the result. Once the losing and winning selections are resolved, a new game cycle starts.

Although roulette can be fun and exciting on its own, there have been numerous attempts to add further fun and excitement by modifying aspects of roulette as structured in different parts of the world. Roulette systems may include a quantity of numbers on the number circle spaced apart and arranged in different manners. The number circles of roulette wheels typically include at least 36 numbers. Some number circles may include additional numbers and/or symbols, and the roulette wheels may include a corresponding number of ball slots, which can change the arrangement of the numbers/symbols of the number circle. Number circles including an extra number are typically numbered “0”, two extra numbers are typically numbered “0” and “00”, etc. The “0” and “00” numbers are typically green and therefore neither even nor odd. FIG. 1 is an exemplary illustration of a prior art roulette wheel system 10, including a roulette wheel 12 that spins in one direction and is surrounded by a stationary annular track 14 within which a ball 16 is spun in the opposite direction of the roulette wheel's spin. The surface of the roulette wheel 12 slopes toward the ball slots 18, which are surrounded by the number circle 19. The number circle corresponds to a 37-number roulette system with one added “0”.

However, many visual modifications to roulette wheel systems are limited to static changes, such as permanent or semi-permanent modifications to one or more aspects of the device. Such visual modifications may also require the game to go offline for a period of time while the modifications are installed on the wheel. This may result in lower profitability and decreased player experience since fewer roulette games are available for play. In addition, visual modifications may become outdated after a period of time and/or due to customer familiarity. This may create additional challenges and costs related to selecting visual modifications that are appealing and will generate excitement for the game over time since any further changes would result in additional costs and servicing time.

Additionally, as more roulette gaming variations become available with different betting schemes, game cycle rates, pay tables, and jackpot options, it may be difficult for a player to learn a new roulette game and keep up with the pace of play. The learning curve for a new game may affect a player's experience and willingness to play, and therefore roulette gaming devices and locations may benefit from addressing such challenges.

### SUMMARY

A roulette wheel system and method of using it are disclosed. A roulette wheel system may include an optical display system configured to project a lighting effect on a top surface of the roulette wheel, wherein the lighting effect corresponds to bet information, and a controller providing signal content to the optical display system, with the signal content producing the lighting effect. The lighting effect may include a first symbol projected at a position adjacent to at least one of a corresponding symbol on the roulette wheel and a corresponding pocket on the roulette wheel. The lighting effect may include a first symbol to indicate a multiplier value and a second symbol to indicate a bet value for an outcome of the roulette wheel. The bet information may correspond to bets received from at least one player station during a betting window, wherein the controller continuously updates the signal content during the betting window to dynamically change the lighting effect based on at least one of a number of bets and a total wager on the outcome. The bet value may also correspond to at least one of a number of bets and a total wager on the outcome.

In some examples, the controller may track a position of the roulette wheel, and the signal content comprises a projection position for the first symbol based on the position of the roulette wheel. For example, the projection position may follow a movement of the roulette wheel.

A player display may communicate with the controller to provide video content including an interactive betting layout and a live view of the roulette wheel with the lighting effect. The display may be positioned above the roulette wheel, and the display may provide an animation comprising the roulette wheel and the lighting effect. In additional examples, a camera may capture video content comprising a live view of the roulette wheel, and the controller may provide the video content to a player display in real time.

Additional systems and methods may include a non-transitory computer-readable medium comprising instructions to be executed by at least one processor. Such instructions may include generating, by a controller, a lighting effect corresponding to bet information received by at least one player station during a betting window and projecting, by an optical display system, the lighting effect on a top surface of a roulette wheel. Examples may dynamically change the lighting effect by changing at least one of a size, a brightness, a color, a length, and a shape of at least one symbol. In some examples, the lighting effect is changed based on at least one of a total number of bets and a total wager on the outcome.

These and other features will be more clearly understood from the following detailed description taken in conjunction with the accompanying drawings and claims. This

Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an illustration of a prior art roulette wheel.

FIG. 2 is a perspective view of a roulette wheel with a visual display rim in accordance with an embodiment.

FIG. 3 is a cross-sectional perspective view of a roulette wheel with a visual display rim in accordance with an embodiment.

FIG. 4 is a cross-sectional side view of a roulette wheel with a visual display rim in accordance with an embodiment.

FIG. 5 is a partial cross-section side view of a roulette wheel with a visual display element in accordance with an embodiment.

FIG. 6 is a representation of display elements in accordance with an embodiment.

FIG. 7 is a roulette wheel system including an optical display system in accordance with an embodiment.

FIG. 8 is an example interactive user interface in accordance with an embodiment.

FIG. 9A is an example display in accordance with an embodiment.

FIG. 9B is an example display screen in accordance with an embodiment.

FIG. 9C is another example display screen in accordance with an embodiment.

FIG. 10 is an example operational method in accordance with an embodiment.

FIG. 11 is a block diagram of an embodiment of a computer system.

### DETAILED DESCRIPTION OF ILLUSTRATIVE EMBODIMENTS

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible; variations can be made to the embodiments described herein; and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

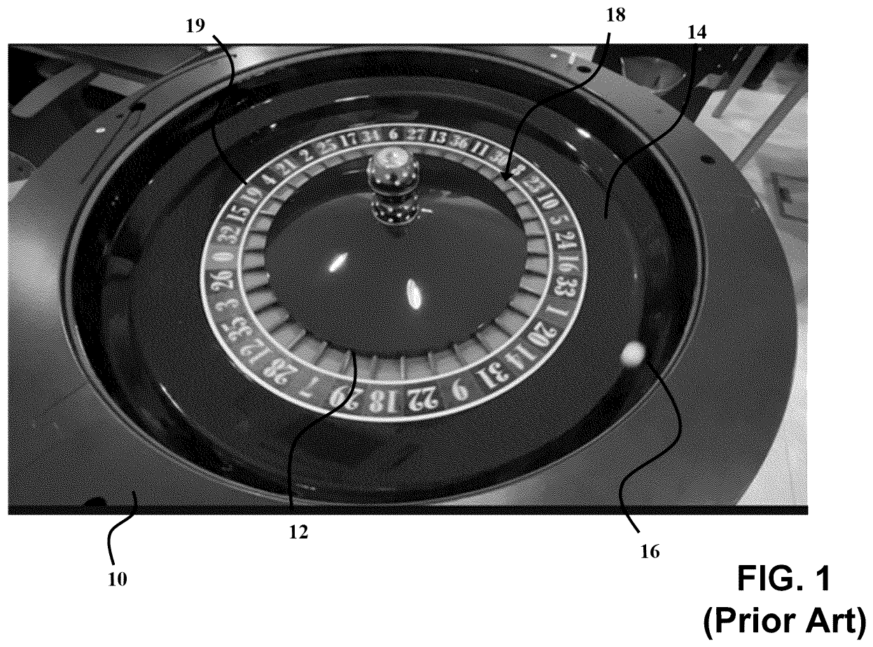

Most roulette systems or mechanisms have a base 10, a cone 12, a stationary rim 14 around which a ball 16 travels, and a rotating roulette wheel 18 positioned in the middle of the base and having pockets into which the ball 16 eventually falls. The roulette wheel includes a number of pockets configured to hold the roulette ball. A number between 0 and 36 (and also 00 on some roulette wheels) and a color (typically green for 0 and 00 and alternating between red and black for the other numbers) are assigned to each of the pockets. Other symbols may be used in place of numbers or symbols and numbers may be mixed together. The stationary rim includes a single, angled annular track in which a single roulette ball is spun. At the beginning of a game cycle, typically after further selections are closed, a dealer will either manually spin the roulette ball in the track or the roulette ball will be launched from a launch tube. The roulette ball spins in the opposite direction of the rotating roulette wheel. When the roulette ball eventually exits the track, the ball will ultimately land in one of the pockets indicating the end of that game cycle. FIG. 1 is an illustration of a prior art roulette system with 37 pockets 18 and the numbers 0-36 on the number circle 19.

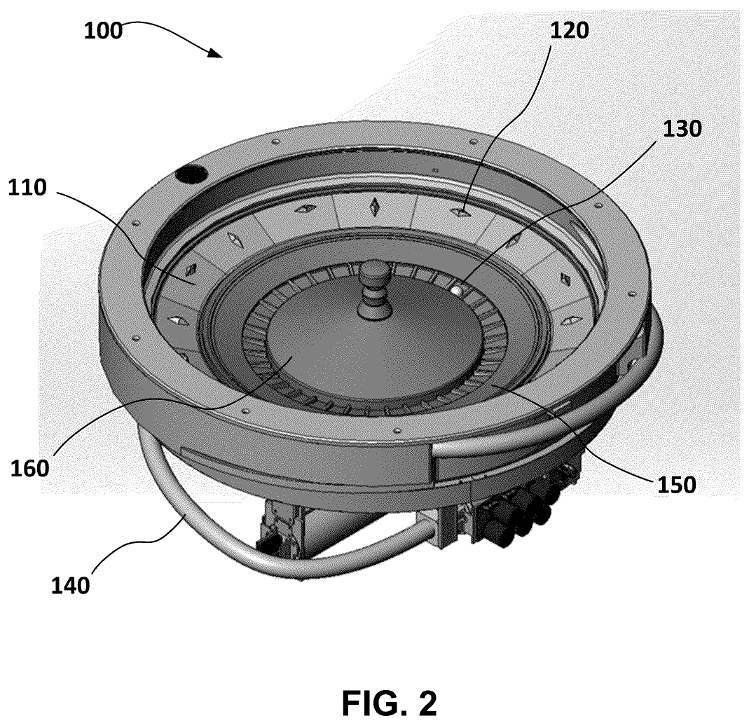

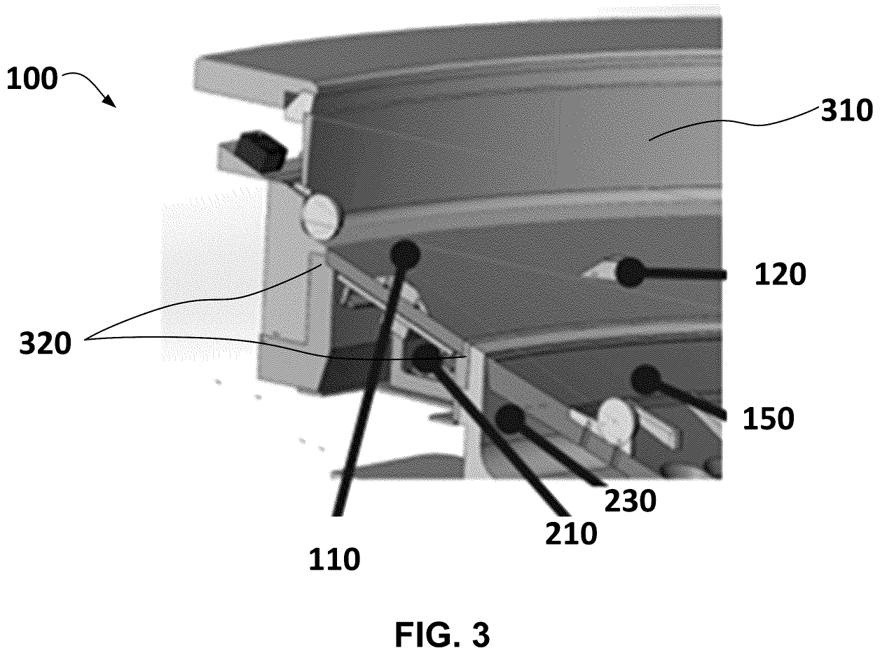

FIG. 2 illustrates a roulette wheel system including a visual display rim 110. When a roulette ball is launched from a launch tube 140, the ball travels around the rim 110 and eventually drops into a pocket 130 (e.g., pocket 130 of the rim 110 is displayed holding a ball) once it loses momentum. In various embodiments, the rim 110 may be stationary, while a roulette wheel 220 (as shown in FIG. 3) spins in a direction opposite the direction of a roulette ball launch. The visual display rim 110 may include one or more raised physical elements, such as canoe 120, which may contact the roulette ball and deflect its path, causing unpredictability and increasing excitement and attention towards the gameplay. Canoes 120 may be placed in any of a variety of positions orientations around the rim 110.

The visual display rim 110 may also include the number circle and pockets, all of which may be made of a transparent, semi-transparent or opaque material of any color or combination of colors. An opaque base may include transparent inserts positioned above lighting elements. In some embodiments, the visual display rim 110 may be glass, such as a transparent polycarbonate glass. In other embodiments, the visual display may include one or more types of transparent materials, including but not limited to plastics, glass, resins, and other thermoplastic polymers and polycarbonate materials.

As best seen in FIGS. 2-5, the roulette wheel 220 may include a number circle area 150 that may be positioned between the visual display rim 110 and the pockets 130. In examples, the number circle area 150 may be provided on a top surface of the roulette wheel and be an extension of the visual display rim 110. The number circle area 150 may also be a transparent, semi-transparent, or opaque material of any color or combination of colors. The opaque material may include transparent sections or blocks therein. In some embodiments, the number circle area 150 is a glass material, such as a transparent polycarbonate glass. In other embodiments, the number circle area 150 may include one or more types of transparent materials, including but not limited to plastics, glass, resins, and other thermoplastic polymers and polycarbonate materials. An optical display system 210 may be positioned beneath the visual display rim 110 as well as extend beneath the number circle area 150 and the pockets 130. The optical display system may serve to display text, numbers, icons, flashes, colors, or any of a variety and combination of lighting effects, which will be visible on or through the visual display rim 110, the number circle area 150, and the pockets 130. The optical display system 210 may include one or more light-emitting diodes (LEDs). In some embodiments, the optical display system 210 includes a display, such one or more liquid crystal displays (LCDs). A combination of various lighting elements may be applied to create a desired visual effect for the display rim 110. For example, the optical display system may include one or more LCD screens installed along the bottom of the rim 110 and one or more LEDs providing additional visual effects.

In embodiments, the number circle area 150 may display the numbers 0-36 as shown on the number circle 19 of FIG. 1 or some other combination of numbers and symbols. In embodiments, the number circle area 150 may rotate with the rest of the roulette wheel 220. In embodiments, the number circle area 150 may be stationary with the visual display rim 110 and the display of the optical display system 210 may simulate the numbers, such as 0-36 or some other combination of numbers and symbols, rotating like they would in FIG. 1 when the roulette wheel 220 rotates.

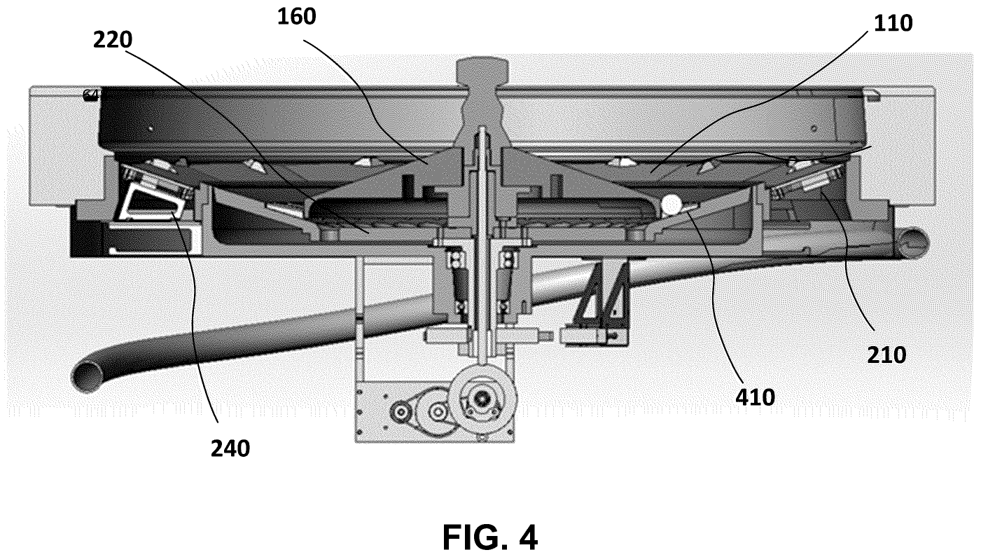

In various embodiments, the optical display system 210 may be directly attached to the bottom side of the display rim 110 and the number circle area 150. In some examples the optical display system 210 may be a removable element. In other examples, the optical display system 210 may be formed as part of the display rim 110, the number circle area 150, and pockets 130. The display rim 110 may additionally have one or more recesses, protrusions, mounts, or other physical elements to attach and/or remove the optical display system 210. For example, support bracket 240, as best seen in FIG. 4, may provide a support upon which the lighting elements 210 and/or the rim 110 may be placed. A similar support bracket 240 may be positioned beneath the number circle area 150 and/or the pockets 130.

A removable and/or interchangeable optical display system may enable efficient replacements or repairs of lighting elements, which would lead to less time that the game is offline. A variety of optical display systems may enable additional lighting display combinations, which could make a game more attractive to current and potential players.

FIGS. 3 and 4 provide an alternate view of the visual display rim, e.g., visual display rim 110, the number circle area 150, the pockets 130, and the roulette system 100 elements. In various embodiments, the visual display rim 110, the number circle area 150, and the pockets 130 are tilted at an angle and positioned above the rest of the roulette wheel 220. The display rim 110 may be stationary, while the roulette wheel 220 and cone 160 may spin in a direction opposite to the launch direction of the roulette ball. As noted, the number circle area 150 may also be stationary but simulate the combination of numbers and symbols rotating, or actually physically rotate with the roulette wheel and cone 160. A spacer clement 230 may separate the rim 110 and wheel 220 so that that the wheel can freely rotate. The spacer element 230 may also be positioned between the pockets 130 and the number circle area 150.

In embodiments, the display rim 110, the number circle area 150 and pockets 130 may be tilted 21° above a horizontal plane of the roulette wheel. Any other tilt angle, or no tilt angle, may be used to position the display rim 110 and its components.

The visual display rim 110 and the number circle area 150 may also be removable elements, fitted into the area between the outer wall 310 and the spacer element 230. For example, the visual display rim 110 may sit in a defined groove 320 formed by one or more elements of the roulette wheel (e.g., outer wall 310, spacer element 320, etc.). The groove 320 may be extended to include the number circle area 150 and the pockets 130. This capability may introduce greater variety to the roulette gaming system. For example, different visual display rims 110 may include different colors and/or materials, with varying canoe shapes, sizes, colors, or other physical elements, and the number circle area 150 and pockets 130 could be modified in ways that may add to the excitement and visual attraction of the game.

FIG. 4 illustrates a cross-sectional side view of the roulette gaming system. In various embodiments, the lighting effects may be controlled via a controller, which may be local to the roulette gaming system or remotely located. A controller may allow game operators to manually change one or more lighting effects or routines, as desired. The controller may also provide pre-programmed routines and effects which may be selected or automatically occur when certain roulette wheel events occur and/or if certain sensors are triggered. Sensors may include, but are not limited to, an optic sensor, proximity sensor, force sensor, pressure sensor, and position sensor.

The controller may communicate with one or more sensors and devices to control a lighting sequence or visual effect. As discussed herein, a sensor may indicate a current status of the game; a position of the roulette ball (e.g., within a launch tube 140, within a pocket 130); contact with a gaming element, such as canoe 120; or any other aspect of the roulette gaming system. For example, a sensor may provide real-time feedback to the controller, e.g., related to a position of the roulette ball, and lighting sequences may correspond to the real-time feedback, e.g., tracking, highlighting, or otherwise indicating a position of the roulette ball.

In an example, a first lighting sequence may occur while the roulette ball is spinning within the track of the wheel, a second lighting sequence may occur when the roulette ball leaves the track, and a third lighting sequence may occur when the ball has landed within a pocket 130. A sensor, e.g., sensor 410, may be an optic sensor, which may identify a presence of a ball in the track and within a particular pocket so as to trigger the different lighting sequences, i.e., the first lighting sequence when the ball is sensed in the track, the second lighting sequence when the ball is no longer sensed in the track but is not yet sensed in a pocket, and the third lighting sequence when the ball is sensed in a pocket.

The visual display rim 110 and optical display system 210 may highlight an arrow, number, identifier, or other lighting effect to indicate the pocket with the roulette ball. In another example, when a sensor (e.g., pressure, force, position, etc.) indicates contact of the roulette ball with a canoe 120, a lighting effect may be triggered, such as highlighting the canoe, or other visual or color effect on the display rim. To further enhance the roulette mechanism and make it easier for players to identify the pocket in which a roulette ball has landed, lighting could be provided to light up the pocket sensed to contain the ball. Again, the lighting could be triggered by a sensor 410 detecting the roulette ball in or not in different locations, such as a pocket.

In some embodiments, the optical display system 210 may display information, such as player information, gaming information, a current score, current winnings, a bet, number of players, a date, time, name, game type, winning numbers, winning bets, and the like. In some examples, the optical display system 210 may cause the visual display rim 110 and/or the number circle area 150 and/or pockets 130 to be a certain color or combination of colors for a period of time. In various embodiments, sound effects may accompany one or more visual displays provided on the visual display rim 110, the number circle area 150, and the pockets 130.

The lighting elements of the visual display rim 110, the number circle area 150, and the pockets 130 may be programmed to automatically run through a lighting sequence(s) and/or produce certain lighting effects when an event occurs during the operation of the roulette system. For example, certain lighting combinations may occur when there is not an active game being played. Flashing lights and colors may be used to attract players to the game. During gameplay, the system may show a current player name and other player or gaming information. Certain lighting and/or sound effects may enhance gameplay, or keep the player's attention, for example. Additional enhancement features include the ability to shine light through one or more crystals embedded in the visual display rim 110, a canoe 120 or other rim element, the number circle area 150, or pockets 130 during a game or when a roulette ball lands in a pocket, such as by highlighting the corresponding number or symbol within the number circle area 150 or shining a light through the pocket to further indicate the outcome of each game or for some other reason.

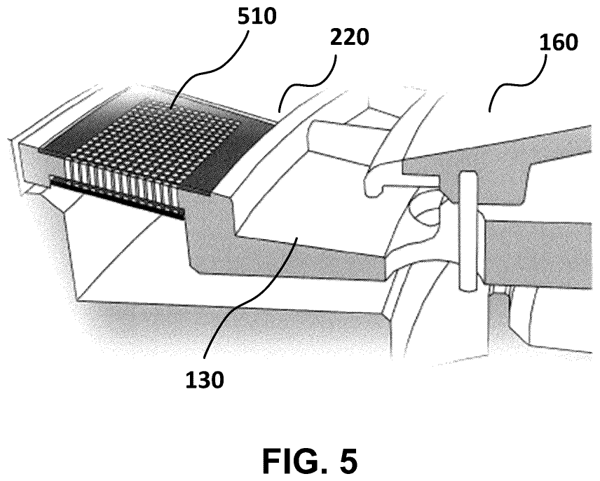

FIG. 5 illustrates a partial cross-sectional side view of a rotatable roulette wheel having a plurality of light sources 510 positioned along the number circle area 150. As shown in FIG. 5, the light sources 510 may include individual light sources, arrays of light sources, light guides positioned above one or more light sources, transparent areas positioned above one or more light sources, etc. The light sources 510 may include one or more LEDs forming an array at each pocket 130. The light sources may be a part of the optical display system 210 discussed herein, and include one or more displays, such as liquid crystal displays (LCDs), or other light projection devices. In other examples, the light sources are part of one or more LED arrays positioned to be viewable along a perimeter of the plurality of pockets on the roulette wheel, e.g., number circle area 150.

Light sources 510 may be provided at each pocket 130 to provide gaming information, such as pocket labels, numbers (e.g., 0, 00, 1-37, etc.), and bonus information. The lighting sources may change before, during, and after gaming events, to convey different gaming information throughout a gaming cycle. Such gaming information may include identifying a winning pocket, a bonus associated with one or more pockets, and any numbers having an associated bet.

A sequence of lighting effects may be generated throughout a game cycle. For example, a first set of lighting effects, such as gameplay rules, betting information and bonuses, bet types, numbers, and symbols may be provided during a betting period. A second set of lighting effects, such as pocket number labels, may be provided after the betting period closes and throughout the roulette ball launch and wheel spin cycle. A third set of lighting effects, such as a winning number, may be provided after a roulette ball comes to rest in a pocket and a winning number and/or other bets are determined. Embodiments may include variations to communicate one or more of a roulette ball position, a number, a symbol, a color, a bonus, a winning outcome, and an animation.

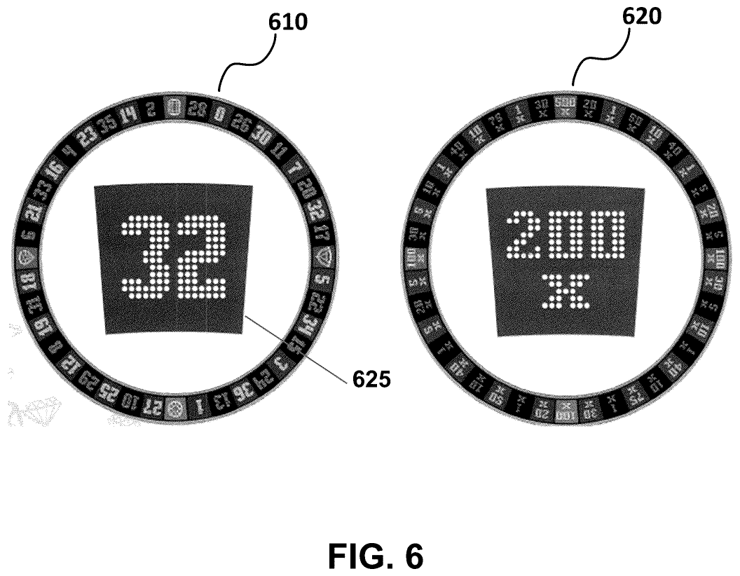

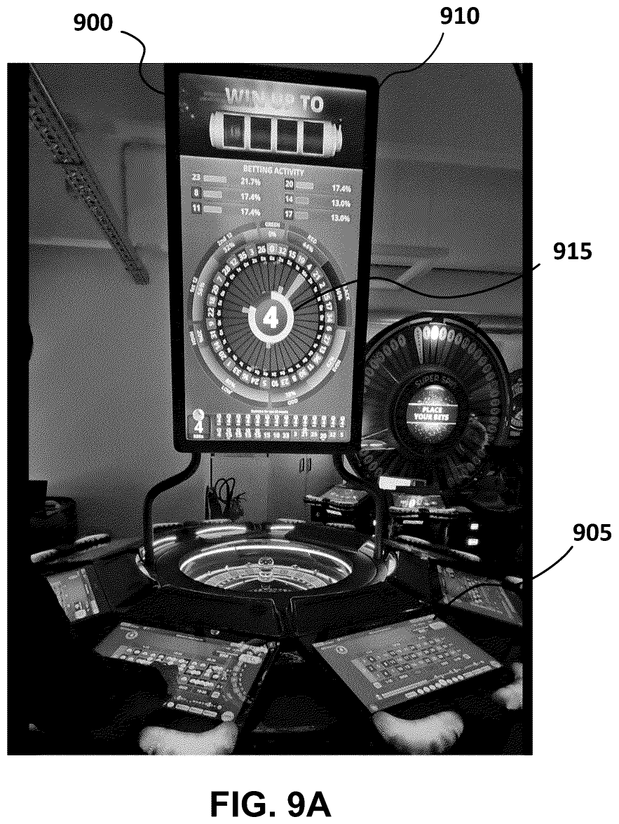

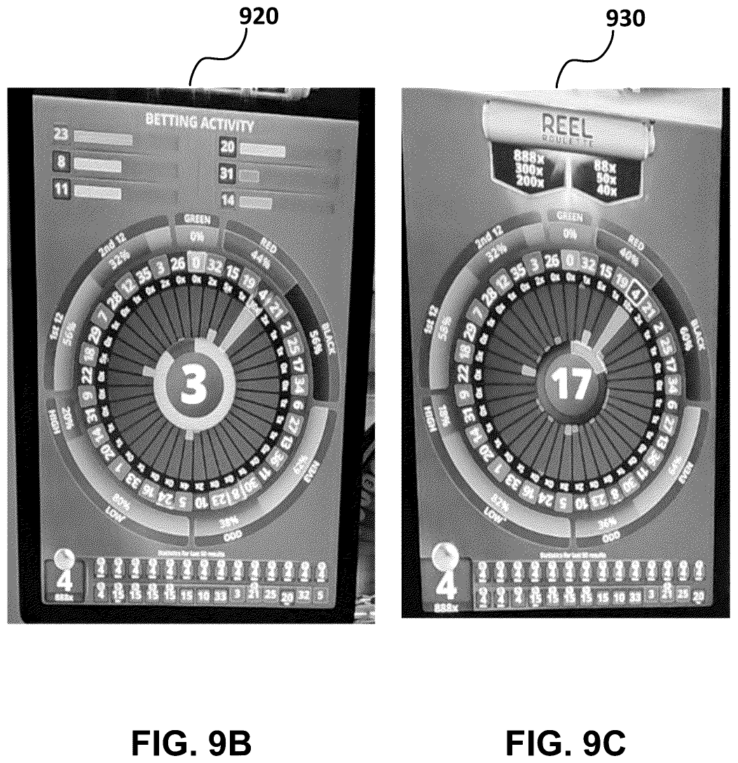

FIG. 6 illustrates two examples with lighting elements along the rotatable rim to label the number circle area 150. In both examples, lighting effects are also provided on the cone 160 covering a central portion 625 of the rotatable roulette wheel. The lighting effect on the cone may be projected from underneath the cone or projected onto the cone from above the cone. As further illustrated in FIG. 9A, a projector could be positioned within the display 900 and configured to display lighting effects on the cone and elsewhere on the wheel. Such lighting effects may be provided based on signal content from the controller. The signal content, as described herein, may represent gaming information, which may include at least one of a roulette ball position, a game timing, a roulette ball launch, a multiplier, a volume of bets being placed, and a gaming outcome. The lighting effects on the cone 160 may be generated using any of the plurality of lighting techniques and lighting elements discussed herein.

On wheel 610, the number wheel area 150 provides labeling information to convey symbols associated with each pocket. The lighting sources 510 show standard roulette wheel numbers and other symbols, such as a diamond, which may indicate a bonus and otherwise correspond with a bet option at an associated betting area. The central portion 625, e.g., on the cone 160, may indicate a past or current winning number or symbol, for example, “32,” which represents the gaming outcome or the number in which the ball fell into its corresponding pocket on the wheel. At wheel 620, light sources in the central portion 625 may indicate a bonus, e.g., 1×-500×, associated with each pocket. The lighting display on the cone 160 may indicate a past, current, or upcoming bonus amount, such as “200×”.

In some examples, the lighting sources may alternate between displaying pocket numbers and associated bonuses. The lighting sources 510 may also provide various lighting effects (e.g., colors, symbols, animations, brightness, etc.) to provide a source of attraction and keep players attentive to the present game. Such features may also help communicate game rules, bonus play information, and the like, to assist new players and introduce new gaming features. These lighting features may be provided along with other lighting effects and animations on the stationary rim, as previously discussed herein. The optical display system may generate lighting effects on the stationary rim (e.g., a transparent, stationary rim) sequentially, alternately, and/or concurrently with any lighting effects on the rotatable roulette wheel and the conc.

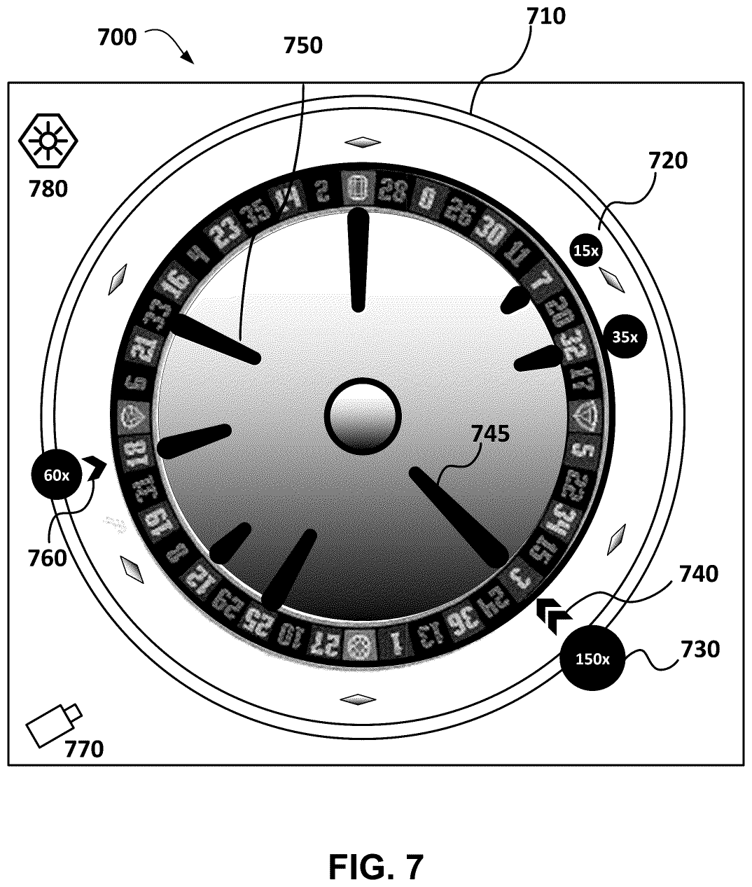

FIG. 7 illustrates a roulette wheel system 700 including an optical display system 780 configured to project a lighting effect on a top surface of a roulette wheel 710. As previously noted, the optical display system 780 could be positioned within the display 900 positioned over the wheel and configured to project images onto the number circle, the cone and elsewhere. The optical display system 780 may include the controller or the controller could be located elsewhere in the roulette system and send signal content to the display system 780.

The lighting effect may include one or more symbols, including but not limited to various shapes, texts, numbers, and the like, each with optional brightness levels, sizes, and colors. A lighting effect symbol 730 may indicate a multiplier value. The multiplier may correspond to one or more numbers in a next round of play and identify which potential outcomes will receive the multiplier, if selected.

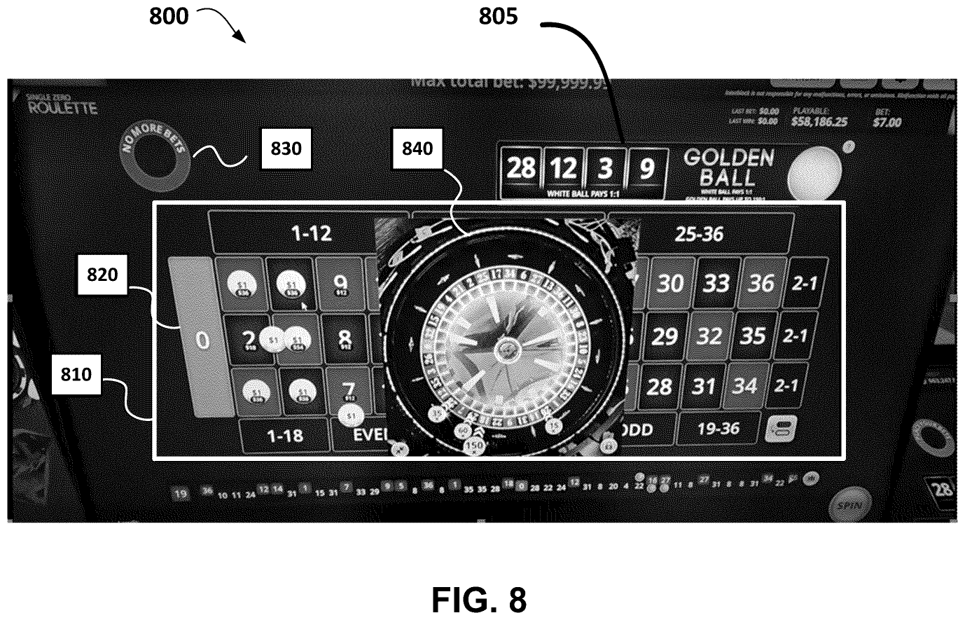

In the illustrated example, roulette numbers 3, 7, 18, and 32 are associated, respectively, with 150×, 15×, 60×, and 35× multiplier values. In an embodiment, the roulette numbers associated with multipliers are selected randomly by the random number generator(s) of the roulette system, which may include the controller. In an embodiment, the roulette numbers associated with the multipliers are illustrated by a virtual slot reel 805 that is spun after all bets have been placed. The virtual slot 805 may randomly select the four roulette numbers and randomly assign the multipliers to them. In an embodiment, the virtual slot 805 is activated every game but using lower multipliers. In an embodiment, the virtual slot is activated in a game when a special roulette ball, such as a golden ball as illustrated in FIG. 8, is randomly launched within the roulette system. The golden ball multipliers may be larger than the multiplier that might apply when multipliers are used for more games.

When selected, a multiplier symbol, e.g., symbol 730 may be projected on the surface of the roulette wheel to indicate its value and the associated roulette number. The multiplier symbol may vary in shape, size, color, and text to draw attention to different aspects, such as a value of the multiplier. For example, symbol 730, which indicates a 150× multiplier, is larger in size than symbol 720, which indicates a 15× multiplier. Additional symbols, such as symbols 740, 760, may be projected to highlight one or more the multiplier values. Symbols 740, 760, for example, may draw attention to outcomes with the highest multiplier values. Symbol 740, showing two arrows, may indicate a greater multiplier value than symbol 760 with a single arrow. Symbols 740 and 760 may therefore provide a quick, easily identifiable visual icon to a user to indicate a relative value of a multiplier. In addition, a multiplier indicator 745 may be projected onto a top, center portion of the roulette wheel, which further corresponds in size to the value of the multiplier. The multiplier indicators 745 corresponds to the larger multiplier and is bigger than other multiplier indicators associated with smaller multipliers. Such symbols may enable a user to distinguish between multiplier values quickly and enable the user to concentrate on watching the results of the game being any of the multiplier numbers. Any of a plurality of symbols may be included to enable a player to easily identify relevant multiplier values and associated outcomes.

A dynamic bet indicator 750 may be projected onto a top, center portion of the roulette wheel. The bet indicator 750 may reflect current bets entered during a betting window, to visually show players where bets are being placed. The bet indicator 750 may be a bar, blocks, lines, or any other symbol, provided in any of a variety of colors, shapes, sizes, and animations, which may dynamically adjust as bets are placed during the betting window. In examples, the bet indicator 750 may increase in length as additional bets are added. The bet indicator 750 may also change, e.g., increase in length, based a bet value associated with the number. For example, bet indicator 750 may indicate, based on its length, that the total amount wagered on 3 is greater than any other numbers or symbols. The dynamic bet indicator 750, similar to symbols 740 and 760, may enable a user to quickly identify where bets are being placed. Dynamic bet indicators may also enhance the speed at which the user may decide to place a bet. Dynamic bet indicators may be displayed while bets are being placed and then replaced with multiplier indicators, if appropriate, once betting has stopped and the multipliers are selected. As shown in FIG. 7, a combination of dynamic bet indicators 750 and multiplier indicators 745 are illustrated.

In an example, a first bet entered at a first outcome (e.g., number 7) may cause a first bet indicator symbol to be provided on the roulette wheel surface. A second bet entered at the first outcome may cause the bet indicator symbol to change. The bet indicator may change a shape, length, color, appearance, and the like dynamically as bets are made. A second bet entered at 7, for example, may cause the bet indicator symbol associated with 7 to grow, e.g., similar to the bet indicator symbol on 12.

In additional examples, as indicated herein, a random selection may determine each value of the set of multiplier values. The set of roulette numbers to be associated with a multiplier value may also be randomly selected. In some examples the random selections may be associated with a pay table. Certain multipliers, for example, may have a higher probability of appearing, whereas other multipliers, such as higher-valued multipliers, may have a lower probability of appearing.

The optical display system 780 may include at least one light source configured to direct light to a top surface of the roulette wheel and create a lighting effect. The optical display system 780 may include a projector and one or more light sources, such as a light-emitting diode (LED), to create a lighting effect on a top surface of the roulette wheel, including any of a plurality of effects. In some examples, the optical display system 780 includes a projection component positioned adjacent to the roulette wheel 710, such as in the display 900, to directly project the lighting effect on to the roulette wheel surface. The optical display system may be provided at a known position within a contained area comprising the roulette wheel to protect the optical display system from being moved or accessed and to ensure accuracy of the lighting effect's position. In other examples, the projector may be located at a position remote from the roulette wheel, such as above the roulette wheel, across a room, and the like, so long as a light projection path to the roulette wheel is available. A separate camera 770 may be used to record activity on the roulette system.

FIG. 8 illustrates an example interactive user interface 800 on a user device (e.g., a player station), which may be associated with various aspects described herein. The interactive user interface 800 may include a virtual reel 805 for selecting multiplier numbers, a betting layout 810 including an arrangement of selections 820 corresponding to a game outcome. The selections 820 may correspond to numbers, symbols, colors, etc. associated with a roulette wheel. Some examples may include 0 or 00 roulette variations, and include 36, 37, or more outcomes. In some examples, the selections 820 may be touch-sensitive when provided on an interactive user interface with a touch screen. One or more selections on the betting layout 810 may be selected during a betting window.

A betting window indicator 830 may provide one or more visual cues for time left to select bets. As illustrated the betting window has closed so bettering window indicator 830 illustrates the text “no more bets.” In embodiments, the betting window indicator 830 may provide a countdown indicating, e.g., how many seconds are left. The countdown numbers may be indicated in a central area of the betting window indicator 830. In addition, a changing circular light could be displayed around an outer circle of the betting window indicator 830 positioned around the central area. The changing circular light could go from light to dark as it moves around the outer circle to match the countdown number. The betting window indicator may also change colors, e.g., green to yellow to red, to indicate that time is running out to place bets.

A streamed video 840 may provide a live view of the roulette wheel. A camera 770 may capture the roulette wheel and stream the video in real time to the user device for display on the interactive user interface 800. The streamed video may show lighting effects projected on a top surface of the roulette wheel (see, e.g., FIG. 7), when it is still, when it is moving, or both. The lighting effects could also create the illusion of stationary text on the rotating wheel instead or rotation with the wheel. The streamed video may be provided on various locations on the interactive user interface 800. In some examples, a user may drag and drop the streamed video 840 to different locations, based on preferences. In other examples, the streamed video 840 may automatically appear after the betting window has closed. The interactive user interface 800 may provide additional options to change the shape, size, and appearance to the streamed video 840.

FIGS. 9A-9C illustrate example screens 910, 920, and 930 providing additional information regarding a roulette game, current bets, and multipliers. In some examples, screens 910, 920, and 930 may be provided on a display 900 positioned above a roulette wheel. The display 900 may be positioned to be viewable from one or more play stations 905 positioned around the roulette wheel, or otherwise associated with the roulette game.

Screens 910, 920, and 930 may provide information relating to one or more of live betting activity, multiplier information, game results, betting outcomes, and the like. Screen 910, for example, provides a live view of betting activity, e.g., from play stations 905. The betting activity may provide a listing of numbers and a percentage indicating a number or a value of bets associated with a particular number, relative to all bets placed for a given round. The given round may be a past round, an upcoming round, or a collection of one or more rounds. For example, screen 910 indicates that 21.7% of bets for a given round were placed on 23. Screen 910 further shows a roulette wheel, which may be a live view of current bets being placed for an upcoming round, along with a live selection of the multiplier values. The multiplier values may be provided via a virtual reel animation, such as virtual reel 805. A betting window indicator 915 may provide a time left to complete betting for a next round of play.

Screen 920 provides another example of betting activity for a next round. Additional metrics may be provided with respect to one or more outcomes of the roulette wheel. For example, past win percentages for each number may be provided. Multiplier values associated with each number may be provided as well.

Screen 930 provides an example of a display indicating multiplier values for a given round. An image, animation, or video on a top portion of the screen may provide an indication of multiplier values to be associated with one or more numbers. On screen 930, multiplier values include 888×, 300×, 200×, 88×, 50×, and 40×. The display may also provide an animation showing a selection of the one or more symbols to be associated with the selected multipliers. The one or more symbols may be selected from the available outcomes of the roulette wheel. As discussed herein, both the multiplier values and the numbers to be associated with each multiplier value may be randomly selected.

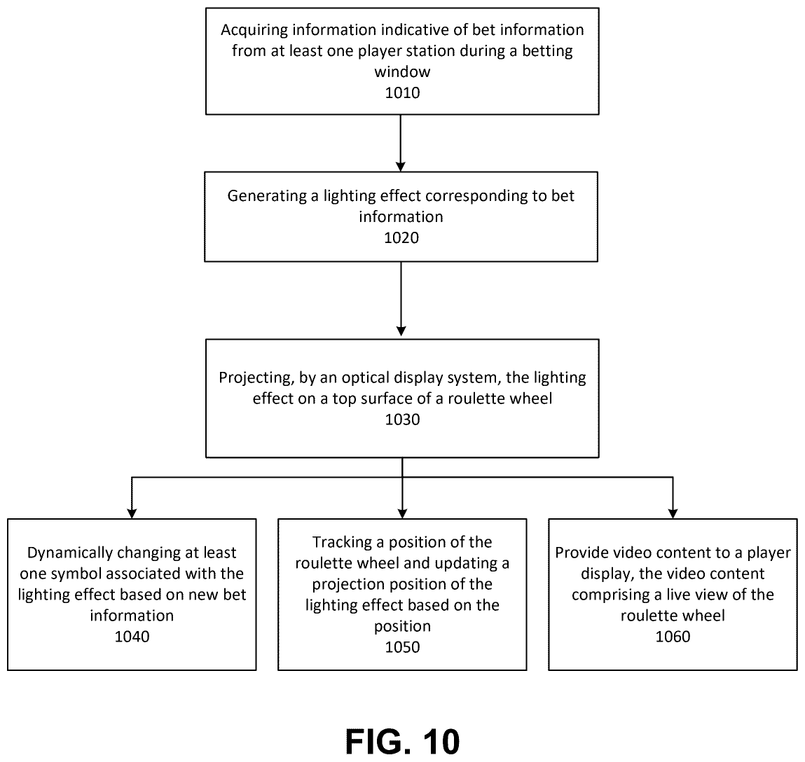

FIG. 10 illustrates a flow chart of operations in accordance with various aspects discussed herein. At block 1010, aspects may acquire information indicative of bet information, the information acquired from at least one player station during a betting window. The bet information may be received via an interactive user interface on a player station. The interactive user interface may include a betting layout providing bet selections corresponding to one or more outcomes of the roulette wheel. The betting layout may further provide a betting window indicator. A live view of the roulette wheel may be streamed to the interactive user interface.

At block 1020, aspects may generate a lighting effect corresponding to bet information. In examples, the lighting effect may include one or more symbols. The symbols may include one or more of a shape, a color, a number, a letter, and the like. At least one symbol may be projected adjacent to at least one of a corresponding symbol on the roulette wheel and a corresponding pocket on the roulette wheel. The lighting effect may also include a first symbol to indicate a multiplier value, and a second symbol to indicate a bet value for an outcome of the roulette wheel. The bet value may correspond to at least one of a number of bets and a total wager on the outcome. In additional examples, bet information may correspond to bets received from at least one player station during a betting window.

In additional examples, the bet information can include one or more of: (i) a volume of a multiplier associated with one of a position on the roulette wheel and (ii) a volume of wagers associated with the position or another position on the roulette wheel. The volume of the multiplier may indicate, for example, at least one of: a value of the multiplier, a historical value of the multiplier, a number of times a multiplier has been associated with the position on the roulette wheel, and the like. The volume of wagers may indicate, for example, a total number of wagers on a particular position during a current round or at least one previous round (e.g., the prior round, a number of prior rounds, all prior rounds, etc.). In other examples, the volume of wagers may indicate a value of wagers associated with the particular position during a current round or at least one previous round. The volume information may therefore enable players to quickly identify popular positions for wagers, and, in examples, current wager information, historical wager information, and other current or historical betting trends, which may be useful to the player to make wager decisions. Such information, which can indicate other players' betting positions, betting trends, popular positions, etc., may further encourage gameplay, increased wagering, player interactions, and an improved gaming experience.

At block 1030, aspects may project, by an optical display system, the lighting effect on a top surface of a roulette wheel. In various examples, the optical display system may be positioned adjacent to the roulette wheel, above the roulette wheel, or otherwise near the roulette wheel. The optical display system may include one or more light sources, such as LEDs.

At block 1040, aspects may dynamically change at least one symbol associated with the lighting effect based on new bet information. In examples, the controller may continuously update the signal content during the betting window and dynamically change the lighting effect based on at least one of a number of bets and a total wager on the outcome. Dynamically changing the lighting effect may further include changing at least one of a size, a brightness, a color, a length, and a shape of at least one symbol. In some examples, the lighting effect may be changed based on at least one of a total number of bets and a total wager on the outcome.

At block 1050, aspects may track a position of the roulette wheel and update a projection position of the lighting effect based on the position of the roulette wheel. A controller may determine a projection position for the lighting effect, and the projection position may follow a movement of the roulette wheel.

At block 1060, aspects may provide video content to a display of a player/user station, the video content including a live view of the roulette wheel. The live view of the roulette wheel may include the lighting effect. The player display may also provide video content such as an interactive betting layout. In additional examples, a display may be positioned above the roulette wheel. The display may provide an animation including the roulette wheel and the lighting effect. In other examples, a camera may capture video content comprising a live view of the roulette wheel, wherein the controller provides the video content to a player display in real time.

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

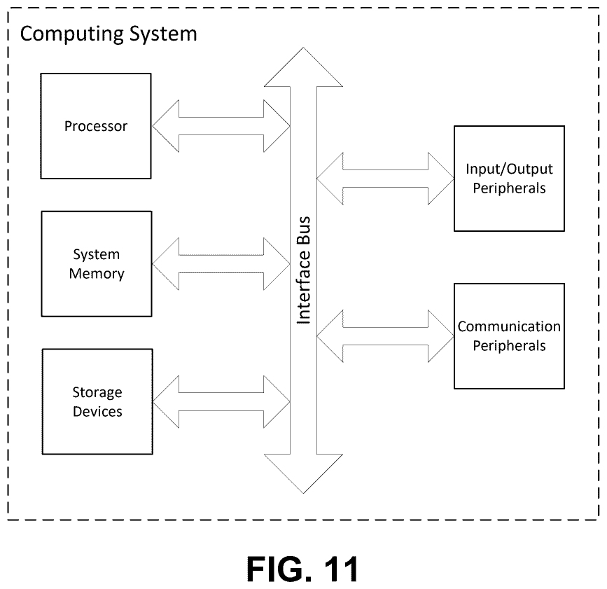

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 11 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer-readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer-readable signal media. A computer-readable signal medium may include a propagated data signal with computer-readable program code embodied therein. Such a propagated signal may take any of variety of forms including, but not limited to, electro-magnetic, optical, or any combination thereof. A computer-readable signal medium may be any computer-readable medium that is not a computer-readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, velocity/acceleration, RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing device. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antennas, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as volatile or non-volatile storage.

In an embodiment, a roulette wheel system, comprising an optical display system configured to project a lighting effect on a top surface of the roulette wheel, wherein the lighting effect corresponds to bet information; a controller providing signal content to the optical display system, the signal content producing the lighting effect, wherein the bet information corresponds to bets received from at least one player station during a betting window, and wherein the controller continuously updates the signal content during the betting window to dynamically change the lighting effect.

In an embodiment, wherein the lighting effect comprises a first symbol projected at a position adjacent to at least one of a corresponding symbol on the roulette wheel and a corresponding pocket on the roulette wheel.

In an embodiment, wherein the controller continuously updates the signal content during the betting window to dynamically change the lighting effect based on at least one of a number of bets and a total wager on the outcome.

In an embodiment, wherein the controller tracks a position of the roulette wheel, and the signal content comprises a projection position for the first symbol based on the position of the roulette wheel.

In an embodiment, wherein the projection position follows a movement of the roulette wheel.

In an embodiment, wherein the bet information includes one or more of a volume of a multiplier associated with one of a position on the roulette wheel and a volume of wagers associated with the position or another position on the roulette wheel.

In an embodiment, further comprising a player display in communication with the controller, wherein the player display provides a video content comprising an interactive betting layout and a live view of the roulette wheel with the lighting effect.

In an embodiment, further comprising a display positioned above the roulette wheel, the display providing an animation comprising the roulette wheel and the lighting effect.

In an embodiment, further comprising a camera capturing video content comprising a live view of the roulette wheel, wherein the controller provides the video content to a player display in real time.

In an embodiment, a method, comprising generating, by a controller, a lighting effect corresponding to bet information received by at least one player station during a betting window; projecting, by an optical display system, the lighting effect on a top surface of a roulette wheel; and continuously updating the signal content by the controller during the betting window to dynamically change the lighting effect based on changes to the bet information.

In an embodiment, further comprising projecting a first symbol of the lighting effect at a position adjacent to at least one of a corresponding symbol on the roulette wheel and a corresponding pocket on the roulette wheel.

In an embodiment, wherein the changes to the bet information include at least one of a number of bets and a total wager on the outcome received by the at least one player station during the betting window.

In an embodiment, wherein dynamically changing the lighting effect comprises changing at least one of a size, a brightness, a color, a length, and a shape of the at least one symbol.

In an embodiment, further comprising changing the lighting effect based on at least one of a total number of bets and a total wager on the outcome.

In an embodiment, further comprising tracking a position of the roulette wheel, and updating a projection position of the lighting effect based on the position of the roulette wheel.

In an embodiment, wherein the lighting effect comprises a first symbol to indicate a multiplier value, and a second symbol to indicate a bet value for an outcome of the roulette wheel.

In an embodiment, wherein the bet value corresponds to at least one of a number of bets and a total wager on the outcome.

In an embodiment, a non-transitory computer-readable medium comprising instructions which, when executed by a processor, cause a computing device to generate, by a controller, a lighting effect corresponding to bet information received by at least one player station during a betting window and project, by an optical display system, the lighting effect on a top surface of a roulette wheel, wherein the bet information corresponds to bets received from the at least one player station during the betting window, and wherein the controller continuously updates the lighting effect based on the bet information.

In an embodiment, wherein the controller is further configured to provide video content to a player display, the video content comprising a live view of the roulette wheel.

In an embodiment, wherein the lighting effect comprises a first symbol projected at a position adjacent to at least one of a corresponding symbol on the roulette wheel and a corresponding pocket on the roulette wheel.

In an embodiment, wherein the lighting effect comprises a first symbol to indicate a multiplier value, and a second symbol to indicate a bet value for an outcome of the roulette wheel.

As previously noted, the various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the discussions herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the discussions herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements, and modifications of the concepts described herein are possible without departing from the underlying principles of the invention. The scope of the invention should therefore be determined only by the following claims and their equivalents.

1. A roulette wheel system, comprising:
an optical display system configured to project a lighting effect on a top surface of the roulette wheel, wherein the lighting effect corresponds to bet information;
a controller providing signal content to the optical display system, the signal content producing the lighting effect, wherein the bet information corresponds to bets received from at least one player station during a betting window, and wherein the controller continuously updates the signal content based on the bet information during the betting window to dynamically change the lighting effect based on changes to the bet information.

2. The roulette wheel system of claim 1, wherein the lighting effect comprises a first symbol projected at a position adjacent to at least one of a corresponding symbol on the roulette wheel and a corresponding pocket on the roulette wheel.

3. The roulette wheel system of claim 2, wherein the controller continuously updates the signal content during the betting window to dynamically change the lighting effect based on at least one of a number of bets and a total wager on the outcome.

4. The roulette wheel system of claim 2, wherein the controller tracks a position of the roulette wheel, and the signal content comprises a projection position for the first symbol based on the position of the roulette wheel.

5. The roulette wheel system of claim 3, wherein the projection position follows a movement of the roulette wheel.

6. The roulette wheel system of claim 1, wherein the bet information includes one or more of (i) a volume of a multiplier associated with one of a position on the roulette wheel and (ii) a volume of wagers associated with the position or another position on the roulette wheel.

7. The roulette wheel system of claim 1, further comprising a player display in communication with the controller, wherein the player display provides a video content comprising an interactive betting layout and a live view of the roulette wheel with the lighting effect.

8. The roulette wheel system of claim 1, further comprising a display positioned above the roulette wheel, the display providing an animation comprising the roulette wheel, and the lighting effect.

9. The roulette wheel system of claim 1, further comprising a camera capturing video content comprising a live view of the roulette wheel, wherein the controller provides the video content to a player display in real time.

10. A method, comprising:
generating, by a controller, a lighting effect corresponding to bet information received by at least one player station during a betting window;
projecting, by an optical display system, the lighting effect on a top surface of a roulette wheel; and
continuously updating the signal content based on the bet information by the controller during the betting window to dynamically change the lighting effect based on changes to the bet information.

11. The method of claim 9, further comprising projecting a first symbol of the lighting effect at a position adjacent to at least one of a corresponding symbol on the roulette wheel and a corresponding pocket on the roulette wheel.

12. The method of claim 9, wherein the changes to the bet information include at least one of a number of bets and a total wager on the outcome received by the at least one player station during the betting window.

13. The method of claim 11, wherein dynamically changing the lighting effect comprises changing at least one of a size, a brightness, a color, a length, and a shape of the at least one symbol.

14. The method of claim 9, further comprising changing the lighting effect based on at least one of a total number of bets and a total wager on the outcome.

15. The method of claim 9, further comprising tracking a position of the roulette wheel, and updating a projection position of the lighting effect based on the position of the roulette wheel.

16. The method of claim 9, wherein the lighting effect comprises a first symbol to indicate a multiplier value, and a second symbol to indicate a bet value for an outcome of the roulette wheel.

17. The roulette wheel system of claim 11, wherein the bet value corresponds to at least one of: a number of bets and a total wager on the outcome.

18. A non-transitory computer-readable medium comprising instructions which, when executed by a processor, cause a computing device to:
generate, by a controller, a lighting effect corresponding to bet information received by at least one player station during a betting window; and
project, by an optical display system, the lighting effect on a top surface of a roulette wheel, wherein the bet information corresponds to bets received from the at least one player station during the betting window, and wherein the controller continuously updates the lighting effect based on changes to the bet information.

19. The non-transitory computer-readable medium of claim 17, wherein the controller is further configured to provide video content to a player display, the video content comprising a live view of the roulette wheel.

20. The non-transitory computer-readable medium of claim 17, wherein the lighting effect comprises a first symbol projected at a position adjacent to at least one of a corresponding symbol on the roulette wheel and a corresponding pocket on the roulette wheel.

21. The non-transitory computer-readable medium of claim 17, wherein the lighting effect comprises a first symbol to indicate a multiplier value, and a second symbol to indicate a bet value for an outcome of the roulette wheel.
